(19) United States
(12) Patent Application Publication
(10) Pub. No.: US 2014/0359733 A1
(43) Pub. Date: Dec. 4, 2014

(54) Authentication System and Method for Authenticating IP Communications Clients at a Central Device

(71) Applicants: Mardoqueo Marquez, Williamstown, NJ (US); Louis Hayner, Woolwich, NJ (US); Frank Iacovino, Philadelphia, PA (US)

(72) Inventors: Mardoqueo Marquez, Williamstown, NJ (US); Louis Hayner, Woolwich, NJ (US); Frank Iacovino, Philadelphia, PA (US)

(73) Assignee: Warwick Valley Networks, Warwick, NY (US)

(21) Appl. No.: 14/367,306

(22) PCT Filed: Dec. 21, 2011
(86) PCT No.: PCT/US11/66438

§ 371 Date: Jun. 20, 2014

(51) Int. Cl. H04L 29/06

(52) U.S. Cl. CPC H04L 63/0846
USPC 726/6

(57) ABSTRACT

A method and system for dynamically authenticating an Internet Protocol (IP) client at a central device comprising a dynamic passcode generation means which is synced to an authentication system within or connected to the central device, the dynamic passcode generation means connected to or built into the IP client; wherein the dynamic passcode generation means periodically generates a passcode according to a preset schedule; the IP client automatically sends the periodically-generated passcode according to the preset schedule to the authentication system to authenticate the IP client; and upon authentication until the IP client is no longer authenticated, the authentication system allows a IP communications services to be provided by the central device.

### BACKGROUND OF THE INVENTION

This invention is in the field of Internet protocol (IP) systems which include IP communications clients which communicate with a central device to originate and terminate calls and, more specifically, to prevention of fraudulent use of IP communications systems by unauthorized persons.

IP communications services to which this invention is addressed include voice over internet protocol (VoIP), video, fax, SMS, and/or voice-messaging applications, that are transported via the Internet or private Intranet rather than via the public switched telephone network (PSTN) used for wired telephony. It is becoming increasingly common for telecommunications providers to use IP communications technology such as telephony over dedicated and public IP networks to connect switching centers and to interconnect with other network providers. Because of the bandwidth efficiency and low costs that IP Communications technology can provide, businesses are migrating from traditional copper-wire telephone systems to IP Communications systems to reduce their phone costs. Hosted service providers provide call connection services through the Internet, Intranets, and/or Virtual Private Networks (VPNs), for example. A central device can be in an enterprise, a local network, a VPN, or across the Internet, for example.

Some IP Communications systems are susceptible to attacks as are any Internet-connected devices. This means that hackers who know about these vulnerabilities (such as insecure passcodes) can institute denial-of-service attacks, harvest customer data, record conversations, and break into voice mailboxes. Hackers have been known to compromise IP communications authentication data such as passcodes and use the data to make multiple international toll calls (known in the art as “racking up calls”) in order to generate fees for which they receive commissions or other remuneration. There are hacker web sites where intercepted token/passcode data is posted so that other hackers can utilize it. Even when the IP communications telephone set passcodes are changed on an annual, monthly, or weekly basis, a hacker can use the intercepted passcode for a long period.

Secure authentication of IP client devices such as VoIP phones has been a difficult problem which others have attempted to address by various methods. Central devices, also known as call servers or soft-switches, can have authentication servers built in, or authentication can be processed by an independent server. According to conventional technology, an application server stores user accounts and authentication information, receives passcode data, registers IP client devices, sets an expiration time for the registration. According to such conventional technology, the authentication information is static and is generally only changed by an administrator of the central call server system such as the soft-switch or authentication server. Conventional soft-switches are programmed to expire registration at an administrator-selected period, which can be set at, for example, between 30 and 3600 seconds. Vulnerability to hackers compromising and using passcodes has been recognized to be a problem and others have attempted solutions. For example, Kurapati, et al., in US 2009/0168756 A1, disclosed a method for authenticating an IP phone and a user of the IP phone by determining whether the IP phone is an authorized device, and whenever the IP phone is authorized a trigger condition occurs, determining whether the user of the IP phone is authorized. The user authorization process initiates a call to the IP phone, sends a request for a passcode to the IP phone, sends a message to disable the IP phone whenever the passcode is invalid, and terminates the call. The user authentication process uses an in-band channel and the IP phone does not run a two factor authentication client application during the authentication process. Kurapati's system has not come into wide use because it requires action by a user in response to display and/or voice prompts initiated by a secure server when a trigger condition occurs wherein the user must enter a personal identification code, a token code, a physical key, an electronic key, numbers, symbols, keystrokes, and/or the like.

IP communications client devices can be of various forms, for example a desktop phone which resembles traditional phones, a tablet, a wireless devices such as a PDA or smartphone, and the like.

There is a need for an improved authentication system for IP communications systems which eliminates the aforementioned vulnerability to unauthorized use of compromised passcodes.

### SUMMARY OF THE INVENTION

The present invention addresses this need and others as will become apparent from the following description and accompanying drawings by employing dynamically generated passcodes which do not require user input. With an automatic, dynamically generated token system, even if an authentication dataset is compromised by a hacker, it would be out of date in a matter of seconds, rather than in a matter of hours, days, weeks, or months as with the conventional authentication systems, thereby preventing known hacking methods and avoiding large unauthorized costs to the phone owners or system operators which currently occur if an IP client such as an VoIP phone is hacked.

The present invention comprises in one aspect method for dynamically authenticating an Internet Protocol (IP) client device at a central device comprising providing a dynamic passcode generation means which periodically generates passcodes acceptable to a synced authentication system at, within, in communication with, or connected to the central device, the dynamic passcode generation means connected to or built into the IP client; wherein the dynamic passcode generation means periodically generates a passcode according to a preset schedule; the IP client automatically sends the periodically-generated passcode according to the preset schedule to the authentication system to authenticate the IP client; and upon authentication, the authentication system allows the IP client to utilize central device communications services.

In another aspect, the invention comprises a system for providing IP communications services to IP client devices comprising a central device adapted to connect voice and video calls from or to a client device, an authentication system connected to or within the central device adapted to receive automatically generated passcodes periodically from a client device according to a preset registration schedule, and a dynamic passcode generation means attached to or built into the a IP-protocol client device, the dynamic passcode generation means adapted to automatically generate passcodes periodically according to the preset schedule, and the dynamic passcode generation means synced to the authentication system.

In one embodiment the central device discontinues the IP communications if a correct authentication passcode is not received according to the preset schedule. The schedule is set at the authentication server or central call server by setting an expiration timer at a predetermined value such as 30 seconds from the time of a successful registration.

In some embodiments the dynamic passcode generation means is a secure token and the phone is provided with an electronic socket, for example a USB port, adapted to receive the secure token. In other embodiments, the dynamic passcode generation function is programmed into a VoIP phone or other IP client device.

The preset schedule can be set to any period, for example every one second up to annually, but since the authentication is automated and has the advantage of not requiring user input of a passcode, it is preferred that the preset registration schedule is set at a number of seconds between 30 and 60.

In most, but not all, cases, the dynamic passcode generation means is configured to generate a unique combination of bits which is processed by the authentication system to determine whether the token is authentic.

One example of a useful type of secure token is an RSA key in which case the authentication system usually comprises an RSA server.

The IP client device can be, by way of example a cell phone, wired phone, wireless phone, or softphone. In one embodiment the IP client device is a wired desktop phone which includes a USB port and the secure token is the RSA key, in which case the phone is programmed to periodically receive use or refer to RSA passcodes or tokens which are communicated to the authorization server or services on a central call server. In another embodiment the IP client device has a built-in dynamic passcode generation means, emulating the function of an RSA key, which can be implemented by hardware in the IP clientor in software within the client's processor.

The central device device can be an IP/PBX soft-switch, for example. Various manufacturers of suitable soft-switches include Cisco, Broadsoft, Avaya, and Asterisk. Soft-switches operate under any of a variety of different protocols, for example Session Initiation Protocol (SIP), MGCP, H.248, SCCP, or H323.

### BRIEF DESCRIPTION OF THE DRAWINGS

The above and further advantages of the invention may be better understood by referring to the following description in conjunction with the accompanying drawings, in which:

FIG. 1 is a flow chart illustrating a single instance of an authentication process according to the present invention.

FIG. 2 is an illustration of an embodiment of a network configuration employing client devices connecting to a central server via a private Intranet and the public Internet according to the invention.

FIG. 3 is an illustration of an embodiment of a network configuration employing all client devices connecting to the central server via the Internet and not employing a private Intranet according to the invention.

FIG. 4 is an illustration of a IP client phone having a USB port being fitted with an RSA token.

FIG. 5 is an illustration of a standard SIP registration process.

### DETAILED DESCRIPTION

Below is a detailed description of certain non-limiting specific embodiments of the invention presented to illustrate how the invention may be carried out and to enable others thereby. The invention is capable of many alternative embodiments and therefore should not be considered as limited to those which are illustrated.

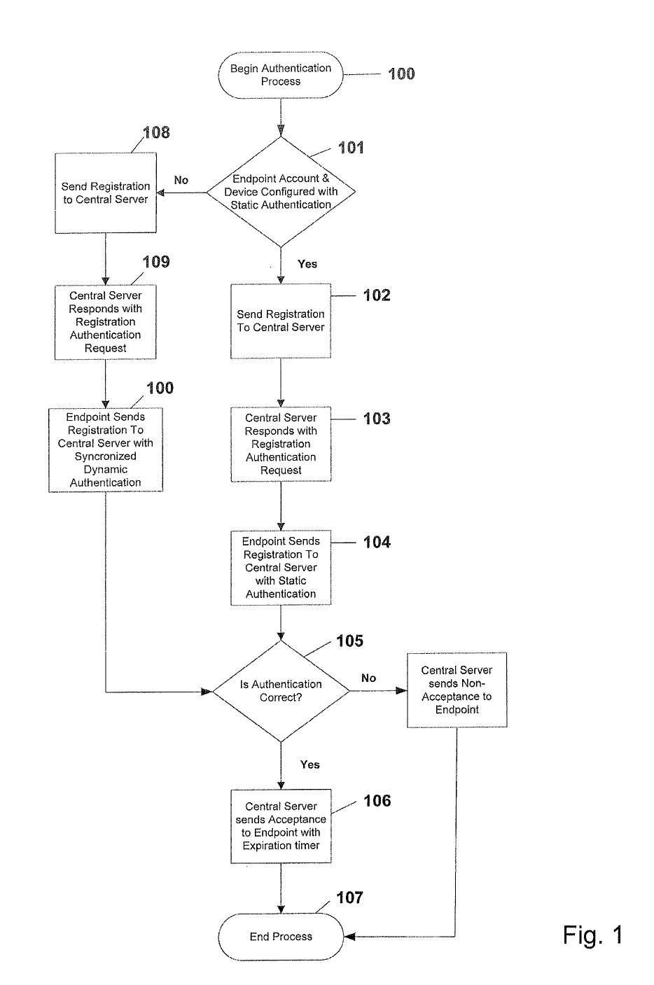

Referring to FIG. 1, the authentication process begins 100 by checking 101 whether the endpoint account is configured with only static authentication. If yes, registration is sent 102 to a central call server 201. The central call server 201 responds 103 with a registration authentication request and the endpoint 202 sends registration to the central call server 201 with static authentication. If the authentication is correct at decision block 105, the central call server 201 sends 106 acceptance to endpoint 202 with an expiration timer and the authentication process concludes 107. The expiration timer can be set by an administrator, typically at 3600 seconds with no user interaction on authentication.

If the endpoint account is not configured 101 with static authentication, registration is sent 108 to the central call server 201 and the central call server responds 109 with a registration authentication request. In response, the endpoint sends 110 registration to the central call server 201 with synchronized dynamic authentication and if correct 105 the process continues as before with the central call server 201 sending acceptance to the endpoint 202 with an expiration timer. Authentication is required even if a phone or other device is not calling or receiving a call.

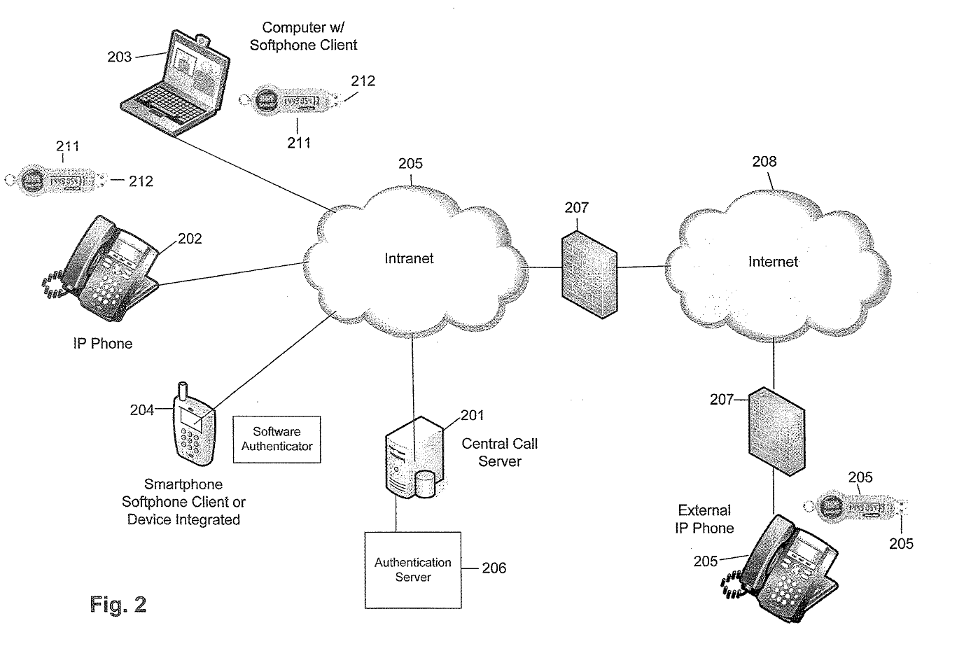

Referring now to FIG. 2, a VoIP phone 202 is illustrated as being in a network with a central call server 201 which in the illustrated embodiment is a Cisco Call Manager brand soft-switch. Other suitable brands of central call servers include, for example, Broadworks, Sonus ASX, and Asterisk. In this embodiment one or more desktop or laptop computers 203, smartphones 204, and the like are in a private Intranet 205 with the central call server 201. The central call server 201 is hard wired to an authentication server 206 which is programmed to provide authentication services to the central call server 201. In other embodiments the authentication server 206 is integral with the central call server 201, either within the same hardware such as in a separate processor or as a software module within a central call server 201 processor. The corporate Intranet 205 communicates with the Internet through a firewall 207. An external IP phone 210 which is authenticated by the dynamically generated passcode system and method in the same manner as IP phones 202 and other devices 203, 204, communicates through a firewall 207 to the central call server 201 in the private Intranet via the Internet in this embodiment. The external IP phone 210 or other external device employs a firewall 207 which creates a virtual private network (VPN), or a built-in VPN concentrator without a firewall. A firewall is not needed for devices within the private Intranet.

The authentication server 206 is an RSA Authentication Express brand server. RSA keys 211 which have USB plugs 212 are inserted in USB ports in laptop 203, IP phone 202 on the corporate Intranet 205, and external IP phone 210. The RSA keys dynamically generate passcodes periodically according to a preset schedule which, in the illustrated embodiment, is every 60 seconds. The passcodes are sent by the IP client to the central call server 201. The Authentication Server 206 or authentication hardware or software module in the central call server 201 registers the IP phone 202, laptop 203, smartphone 204, and/or external IP phone 210 upon receipt of a passcode generated by the RSA keys, and sets a passcode expiration time. Conventional central call servers are programmed to set a passcode expiration time when they register an IP phone or other device. Using the dynamically generated passcode method and apparatus of the invention, the central call server 201 sets an expiration time of on the order of seconds, for example 30 seconds, upon authentication of a passcode, thereby requiring a new passcode every 30 seconds. If the internal IP phone 202, external IP phone 210, or other device does not provide a valid new passcode by the expiration time, the device is unregistered. Only upon authentication by the Authentication Server 206 is a call from an IP phone, computer, smartphone, or the like routed to the destination device by the Central Call Server, either over the Intranet if to a destination IP phone or other device in the Intranet 205, or over the Internet 208 if the destination is an external device such as the external IP phone 210.

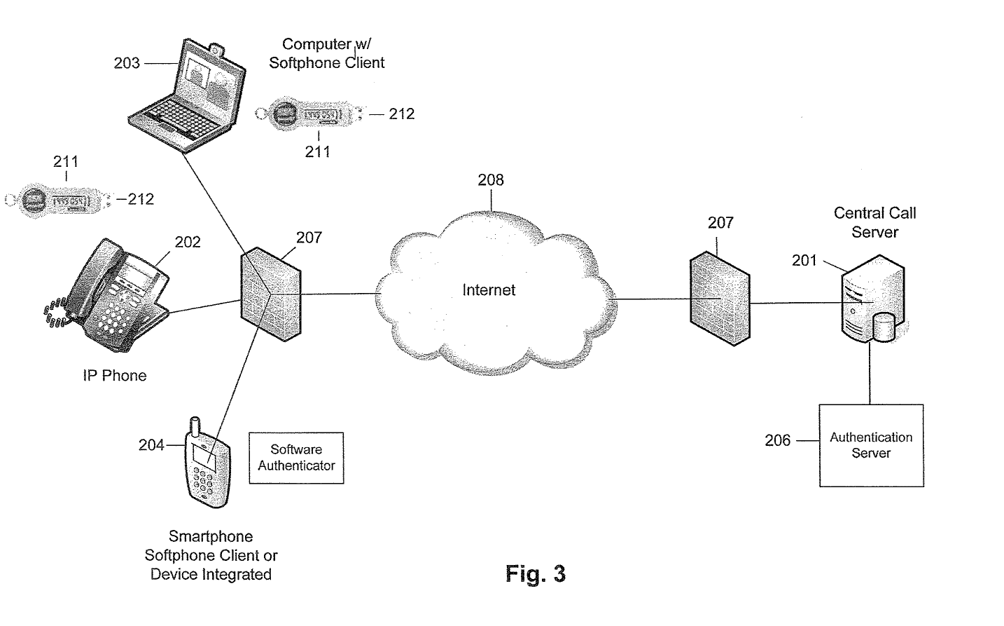

Referring now to FIG. 3, a second embodiment of the invention is illustrated wherein the central call server is connected to the Internet 205 as are the IP phone 202 and any other devices which make or receive calls such as laptop 203 and smartphone 204. No Intranet is set up in this embodiment. In this embodiment the client endpoints communicate to a call server across the Internet.

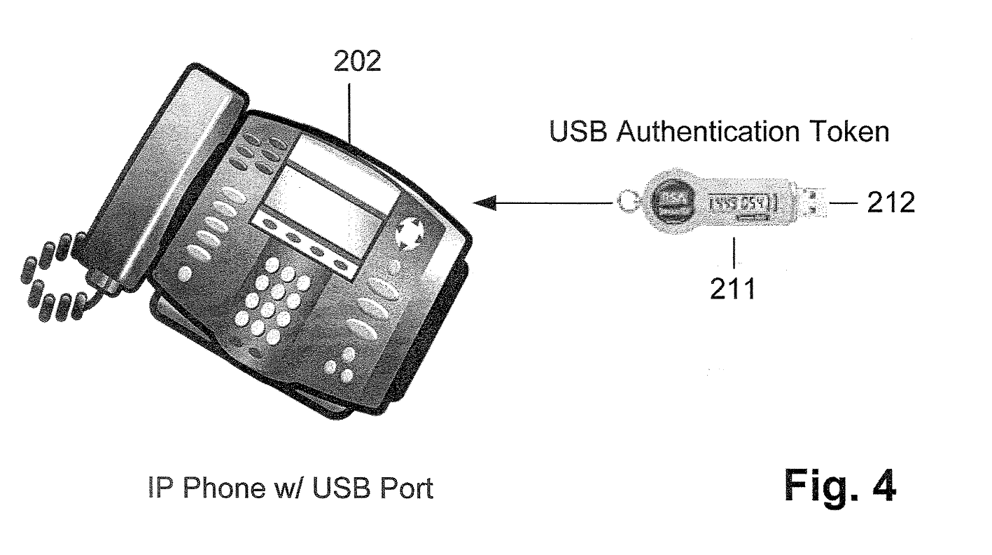

FIG. 4 illustrates a VoIP client phone 202 with a USB port (not shown) and a USB authentication token 211 with a USB plug 212 which fits within the USB port of the phone 202.

Smartphone 204 in the illustrated embodiments does not make use of an RSA key to dynamically generate passcodes which are read by the authentication server 206. Rather, the smartphone 204 is pre-programmed with a dynamic passcode generation means which generates RSA-format passcodes according to a preset schedule, and the RSA Authentication Server 206 is programmed to accept such passcodes according to such preset schedule if they are valid. If a smartphone, IP phone, or other device tries to make a call through the central call server without having sent a valid passcode to the central call server 201 according to the schedule, the call request will be rejected by the central call server 201/authentication server 206.

The dynamic passcode generation and corresponding authentication service at the central call server 201 level can be implemented in an existing conventional IP communications system on a device-by-device basis, with each conventional IP phone or other IP client device in a private network being updated with a dynamic token/passcode generation means, or a new set of IP client devices can replace a conventional set. An administrator can elect to use the dynamic token/passcode generation system on only a select class of IP client devices, for example only external VoIP phones which are most subject to hacking Referring back to FIG. 1, the central call server in step 101 determines whether a particular endpoint, i.e., IP client, is configured with a static or dynamic passcode generator and carries out conventional authentication steps 102, 103, 104, 106, if the client does not have a dynamic passcode generator.

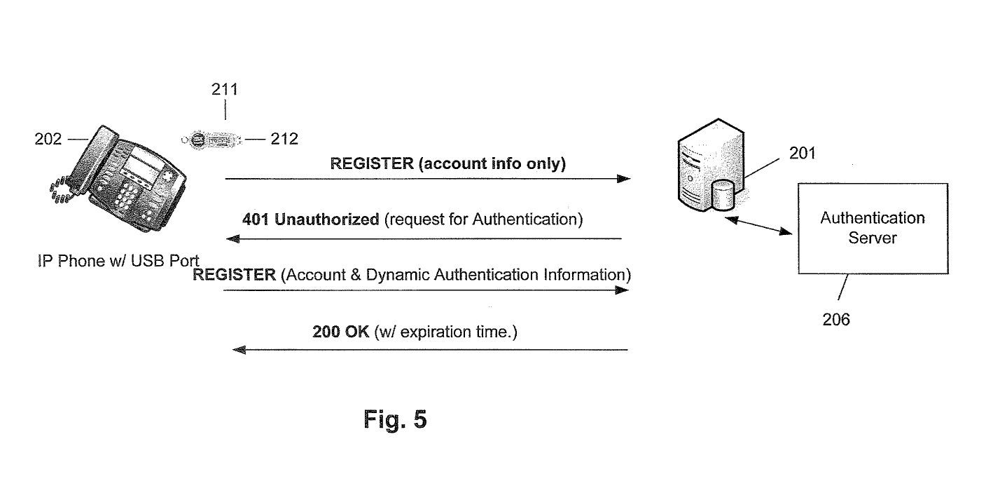

FIG. 5 shows IP client 202 with a USB token 211 which first registers with the central call server 201. The central server 201 denies registration with a 401 Unauthorized code. The IP client 202 then registers with the central device 201 and includes dynamic authentication information. The central device 201 validates the authentication passcode within the authentication information with the authentication server 206. If authentication information including the passcode is correct, the central device 201 sends a 200 OK code to the client with an expiration time.

Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

What is claimed is:

1. A method for authenticating a IP communications client device at a central device comprising:
providing a dynamic passcode generation means at the IP communications client which is synced to an authentication system within or connected to the central device;
wherein the dynamic passcode generation means periodically generates a passcode according to a preset schedule; the IP communications client automatically sends the periodically-generated passcode according to the preset schedule to the authentication system to authenticate the IP phone; and, upon authentication, the authentication system allows the IP client to utilize central device communications services.

2. The method of claim 1 wherein the authentication system sets a passcode expiration time according to the preset schedule and discontinues authentication of the IP client if a correct passcode is not received prior to the expiration.

3. The method of claim 1 wherein the dynamic passcode generation means is a secure token and the phone is provided with an electronic socket adapted to receive the secure token.

4. The method of claim 1 wherein dynamic passcode generation means is a secure token and the phone is provided with a USB port adapted to receive the secure token.

5. The method of claim 1 wherein the preset schedule is set at a number of seconds between 30 and 60.

6. The method of claim 1 wherein the dynamic passcode generation means is configured to generate a unique combination of bits according to the schedule which is processed by the authentication system to determine whether combination of bits is authentic.

7. The method of claim 1 wherein dynamic passcode generation means is an RSA key and the authentication system comprises an RSA server.

8. The method of claim 1 wherein the IP client is selected from the group consisting of a cell phone, wired phone, wireless phone, and softphone.

9. The method of claim 1 wherein the central device an IP/PBX.

10. The method of claim 1 wherein the central device an is a soft-switch.

11. A system for providing IP communications services comprising a IP client device and a central device adapted to originate and terminate voice and video calls from the IP client device, an authentication system associated with the central device adapted to receive automatically generated passcodes periodically from the IP client device according to a preset registration schedule, and dynamic passcode generation means attached to or within the IP client device, the dynamic passcode generation means adapted to automatically generate passcodes periodically according to the preset schedule, and the dynamic passcode generation means synced to the authentication system.

12. The system of claim 11 wherein the IP client is selected from the group consisting of a cell phone, wired phone, wireless phone, and softphone.

13. The system of claim 11 wherein the central device is a soft-switch.

14. The system of claim 11 wherein the secure dynamic passcode generation means is synced to the central device and is adapted to generate passcodes every x seconds wherein x is between 30 and 60.

15. The system of claim 11 wherein the dynamic passcode generation means is a secure token and the IP client includes a USB port adapted to receive the secure token.
